(19) United States
(12) Patent Application Publication
(10) Pub. No.: US 2013/0272219 A1
(43) Pub. Date: Oct. 17, 2013

(54) METHODS AND APPARATUS FOR BACKHAUL SHARING BY FEMTOCELLS

(71) Applicant: QUALCOMM Incorporated, San Diego, CA (US)

(72) Inventors: Damanjit SINGH, San Diego, CA (US); Peerapol TINNAKORNSRISUPHAP, San Diego, CA (US); Chirag Sureshbhai PATEL, San Diego, CA (US); Mehmet YAVUZ, San Diego, CA (US); Soumya DAS, San Diego, CA (US); Andrei Dragos RADULESCU, San Diego, CA (US)

(21) Appl. No.: 13/797,643

(22) Filed: Mar. 12, 2013

Related U.S. Application Data
(60) Provisional application No. 61/610,351, filed on Mar. 13, 2012.

(51) Int. Cl. H04W 28/20

(52) U.S. Cl. CPC H04W 28/20
USPC 370/329

(57) ABSTRACT

Methods and apparatus are disclosed for femtocell backhaul sharing. The method includes determining whether an available bandwidth for communication by the network entity is below a bandwidth threshold. The method includes requesting additional bandwidth from at least one neighbor network node in response to determining that the available bandwidth is below the bandwidth threshold. The method includes receiving configuration information from the at least one neighbor network node to increase the available bandwidth by at least a portion of the requested additional bandwidth.

### CROSS-REFERENCE TO RELATED APPLICATION

The present application for patent claims priority to Provisional Application No. 61/610,351, filed Mar. 13, 2012, entitled “METHOD AND APPARATUS FOR BACKHAUL SHARING BY FEMTOCELLS”, which is assigned to the assignee hereof, and is hereby expressly incorporated in its entirety by reference herein.

### BACKGROUND

I. Field

The present disclosure relates generally to communication systems, and more specifically to techniques for backhaul sharing by femtocells.

II. Background

Wireless communication networks are widely deployed to provide various communication content such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of mobile entities, such as, for example, user equipments (UEs). A UE may communicate with a base station via the downlink (DL) and uplink (UL). The DL (or forward link) refers to the communication link from the base station to the UE, and the UL (or reverse link) refers to the communication link from the UE to the base station.

The 3rd Generation Partnership Project (3GPP) Long Term Evolution (LTE) represents a major advance in cellular technology as an evolution of Global System for Mobile communications (GSM) and Universal Mobile Telecommunications System (UMTS). The LTE physical layer (PHY) provides a highly efficient way to convey both data and control information between base stations, such as an evolved Node Bs (eNBs), and mobile entities, such as UEs.

In recent years, users have started to replace fixed line broadband communications with mobile broadband communications and have increasingly demanded great voice quality, reliable service, and low prices, especially at their home or office locations. In order to provide indoor services, network operators may deploy different solutions. For networks with moderate traffic, operators may rely on macro cellular base stations to transmit the signal into buildings. However, in areas where building penetration loss is high, it may be difficult to maintain acceptable signal quality, and thus other solutions are desired. New solutions are frequently desired to make the best of the limited radio resources such as space and spectrum. Some of these solutions include intelligent repeaters, remote radio heads, and small-coverage base stations (e.g., picocells and femtocells).

The Femto Forum, a non-profit membership organization focused on standardization and promotion of femtocell solutions, defines femto access points (FAPs), also referred to as femtocell units, to be low-powered wireless access points that operate in licensed spectrum and are controlled by the network operator, can be connected with existing handsets, and use a residential digital subscriber line (DSL) or cable connection for backhaul. In various standards or contexts, a FAP may be referred to as a home node B (HNB), home e-node B (HeNB), access point base station, etc.

### SUMMARY

Methods and apparatus for backhaul sharing by femtocells are described in detail in the detailed description, and certain aspects are summarized below. This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

In an aspect, a method wireless communication method is operable by a network entity. The method includes determining whether an available bandwidth for communication by the network entity is below a bandwidth threshold. The method includes requesting additional bandwidth from at least one neighbor network node in response to determining that the available bandwidth is below the bandwidth threshold. The method includes receiving configuration information from the at least one neighbor network node to increase the available bandwidth by at least a portion of the requested additional bandwidth.

In another aspect, a wireless communication apparatus includes at least one processor configured to determine whether an available bandwidth for communication by the network entity is below a bandwidth threshold, request additional bandwidth from at least one neighbor network node upon a determination that the available bandwidth is below the threshold, and receiving configuration information from the at least one neighbor network node to increase the available bandwidth by at least a portion of the requested additional bandwidth. The wireless communication apparatus includes a memory coupled to the at least one processor for storing data.

In another aspect, a wireless communication apparatus includes means for determining whether an available bandwidth for communication by the network entity is below a bandwidth threshold. The wireless communication apparatus includes means for requesting additional bandwidth from at least one neighbor network node in response to determining that the available bandwidth is below the bandwidth threshold. The wireless communication apparatus includes means for receiving configuration information from the at least one neighbor network node to increase the available bandwidth by at least a portion of the requested additional bandwidth.

In another aspect, computer program product includes a computer-readable medium including code for causing at least one computer to determine whether an available bandwidth for communication by the network entity is below a bandwidth threshold. The computer-readable medium include code for causing the at least one computer to request additional bandwidth from at least one neighbor network node in response to determining that the available bandwidth is below the bandwidth threshold. The computer-readable medium include code for causing the at least one computer to receive configuration information from the at least one neighbor network node to increase the available bandwidth by at least a portion of the requested additional bandwidth.

In yet another aspect, a wireless communication method is operable by a network entity. The wireless communication method includes receiving a request for additional bandwidth from a neighbor network node. The wireless communication method includes determining whether an available bandwidth for communication by the network entity is above a bandwidth threshold. The wireless communication method includes providing configuration information to the neighbor network node to share a portion of the available bandwidth with the neighbor network node, in response to determining that the available bandwidth is above the threshold.

In yet another aspect, a wireless communication apparatus includes at least one processor configured to receive a request for additional bandwidth from a neighbor network node, determine whether an available bandwidth for communication by the network entity is above a bandwidth threshold, and provide configuration information to the neighbor network node to share a portion of the available bandwidth with the neighbor network node, in response to determining that the available bandwidth is above the threshold. The wireless communication apparatus includes a memory coupled to the at least one processor for storing data.

In yet another aspect, a wireless communication apparatus includes means for receiving a request for additional bandwidth from a neighbor network node. The wireless communication apparatus includes means for determining whether an available bandwidth for communication by the network entity is above a bandwidth threshold. The wireless communication apparatus includes means for providing configuration information to the neighbor network node to share a portion of the available bandwidth with the neighbor network node, in response to determining that the available bandwidth is above the threshold.

In yet another aspect, a computer program product includes a computer-readable medium including code for causing at least one computer to receive a request for additional bandwidth from a neighbor network node. The computer-readable medium includes code for causing at least one computer to determine whether an available bandwidth for communication by the network entity is above a bandwidth threshold. The computer-readable medium includes code for causing at least one computer to provide configuration information to the neighbor network node to share a portion of the available bandwidth with the neighbor network node, in response to determining that the available bandwidth is above the threshold.

In another aspect, a wireless communication method is operable by a network entity. The wireless communication method includes determining a bandwidth usage of at least one network node during at least one time period. The wireless communication method includes adjusting a bandwidth capacity of the at least one network node based on the determined bandwidth usage.

In another aspect, a wireless communication apparatus includes at least one processor configured to determine a bandwidth usage of at least one network node during at least one time period, and adjust a bandwidth capacity of the at least one network node based on the determined bandwidth usage. The wireless communication apparatus includes a memory coupled to the at least one processor for storing data.

In another aspect, a wireless communication apparatus includes means for determining a bandwidth usage of at least one network node during at least one time period. The wireless communication apparatus includes means for adjusting a bandwidth capacity of the at least one network node based on the determined bandwidth usage.

In another aspect, a computer program product includes a computer-readable medium including code for causing at least one computer to determine a bandwidth usage of at least one network node during at least one time period. The computer-readable medium includes code for causing at least one computer to adjust a bandwidth capacity of the at least one network node based on the determined bandwidth usage.

In yet another aspect, a wireless communication method operable by a network entity. The wireless communication method includes initiating internet protocol (IP) flow packet counting for a user account. The wireless communication method includes determining whether the IP flow is transmitted via a specified network entity. The wireless communication method includes suspending IP flow packet counting upon a determination the IP flow is transmitted via the specified network entity.

In yet another aspect, a wireless communication apparatus includes at least one processor configured to: initiate internet protocol (IP) flow packet counting for a user account, determine whether the IP flow is transmitted via a specified network entity, and suspend IP flow packet counting upon a determination the IP flow is transmitted via the specified network entity. The wireless communication apparatus a memory coupled to the at least one processor for storing data.

In yet another aspect, a wireless communication apparatus includes means for initiating internet protocol (IP) flow packet counting for a user account. The wireless communication apparatus includes means for determining whether the IP flow is transmitted via a specified network entity. The wireless communication apparatus includes means for suspending IP flow packet counting upon a determination the IP flow is transmitted via the specified network entity.

In yet another aspect, a computer program product includes a computer-readable medium including code for causing at least one computer to initiate internet protocol (IP) flow packet counting for a user account. The computer-readable medium include code for causing the at least one computer to determine whether the IP flow is transmitted via a specified network entity. The computer-readable medium include code for causing the at least one computer to suspend IP flow packet counting upon a determination the IP flow is transmitted via the specified network entity.

### BRIEF DESCRIPTION OF THE DRAWINGS

FIG. 1 is a block diagram conceptually illustrating an example of a telecommunications system.

FIG. 2 illustrates a planned or semi-planned wireless communication environment.

FIG. 3 is a block diagram illustrating a communication system.

FIG. 4 is a simplified block diagram of several sample aspects of a communication system.

FIG. 5 illustrates aspects of interference management components in a communication system.

FIGS. 6A-C illustrate example wireless communication environments configured for backhaul sharing.

FIG. 7A illustrates aspects of the methodology for backhaul sharing by femtocells.

FIG. 7B illustrates other aspects of the methodology for backhaul sharing by femtocells.

FIG. 7C illustrates yet other aspects of the methodology for backhaul sharing by femtocells.

FIG. 8 illustrates another embodiment of the methodology for backhaul sharing by femtocells.

FIG. 9 illustrates aspects of the methodology for backhaul management of femtocells.

FIG. 10 illustrates aspects of a methodology for managing IP flow packet counting.

FIG. 11 shows an embodiment of an apparatus for backhaul sharing by femtocells, in accordance with the methodology of FIGS. 7A-7C.

FIG. 12 shows another embodiment of an apparatus for backhaul sharing by femtocells, in accordance with the methodology of FIG. 8.

FIG. 13 shows yet another embodiment of an apparatus for backhaul management of femtocells, in accordance with the methodology of FIG. 9.

FIG. 14 shows an embodiment of an apparatus for managing IP flow packet counting, in accordance with the methodology of FIG. 10.

### DETAILED DESCRIPTION

Techniques for interference management in a wireless communication system are described herein. The techniques may be used for various wireless communication networks such as wireless wide area networks (WWANs) and wireless local area networks (WLANs). The terms “network” and “system” are often used interchangeably. The WWANs may be CDMA, TDMA, FDMA, OFDMA, SC-FDMA and/or other networks. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA, which employs OFDMA on the downlink (DL) and SC-FDMA on the uplink (UL). UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). A WLAN may implement a radio technology such as IEEE 802.11 (Wi-Fi), Hiperlan, etc.

The techniques described herein may be used for the wireless networks and radio technologies mentioned above as well as other wireless networks and radio technologies. For clarity, certain aspects of the techniques are explained in the exemplary context of 3GPP networks, and more particularly in the context of the interference management for such networks. The word “exemplary” is used herein to mean “serving as an example, instance, or illustration.” Any embodiment described herein as “exemplary” is not necessarily to be construed as preferred or advantageous over other embodiments.

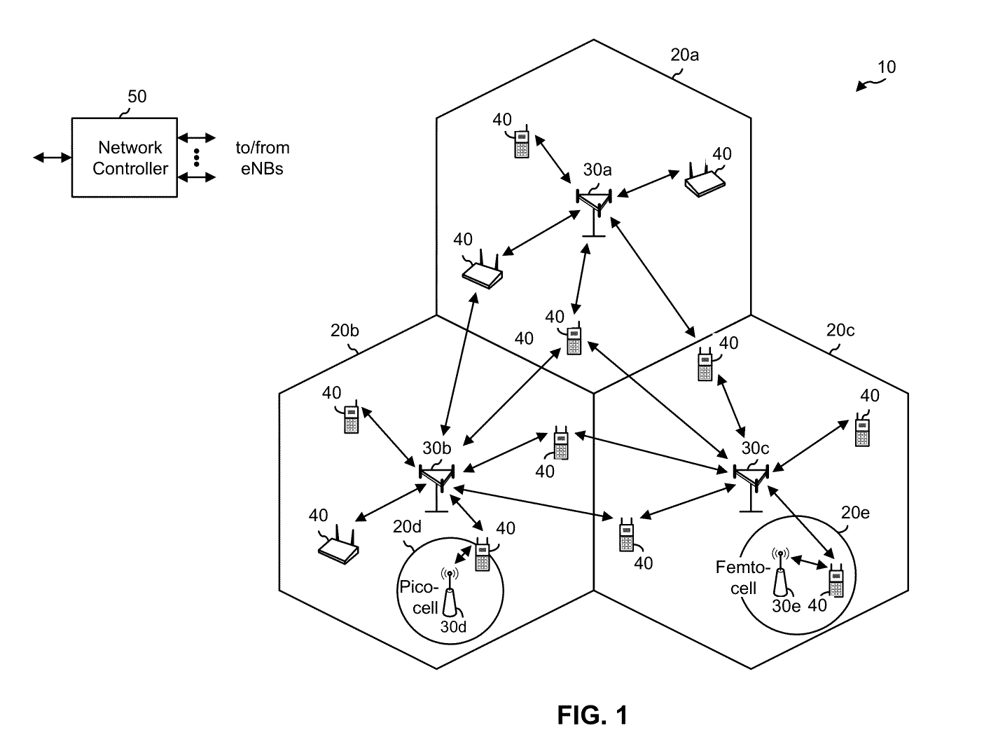

FIG. 1 shows a wireless communication network 10, which may be an LTE network or some other wireless network (e.g., a 3G network or the like). Wireless network 10 may include a number of evolved Node Bs (eNBs) 30 and other network entities. An eNB may be an entity that communicates with mobile entities (e.g., user equipment (UE)) and may also be referred to as a base station, a Node B, an access point, etc. Although the eNB typically has more functionalities than a base station, the terms “eNB” and “base station” are used interchangeably herein. Each eNB 30 may provide communication coverage for a particular geographic area and may support communication for mobile entities (e.g., UEs) located within the coverage area. To improve network capacity, the overall coverage area of an eNB may be partitioned into multiple (e.g., three) smaller areas. Each smaller area may be served by a respective eNB subsystem. In 3GPP, the term “cell” can refer to the smallest coverage area of an eNB and/or an eNB subsystem serving this coverage area, depending on the context in which the term is used.

An eNB may provide communication coverage for a macro cell, a picocell, a femtocell, and/or other types of cell. A macro cell may cover a relatively large geographic area (e.g., several kilometers in radius) and may allow unrestricted access by UEs with service subscription. A picocell may cover a relatively small geographic area and may allow unrestricted access by UEs with service subscription. A femtocell may cover a relatively small geographic area (e.g., a home) and may allow restricted access by UEs having association with the femtocell (e.g., UEs in a Closed Subscriber Group (CSG), or closed access). In the example shown in FIG. 1, eNBs 30a, 30b, and 30c may be macro eNBs for macro cell groups 20a, 20b, and 20c, respectively. Each of the cell groups 20a, 20b, and 20c may include a plurality (e.g., three) of cells or sectors. An eNB 30d may be a pico eNB for a picocell 20d. An eNB 30e may be a femto eNB or femto access point (FAP) for a femtocell 20e.

Wireless network 10 may also include relays (not shown in FIG. 1). A relay may be an entity that can receive a transmission of data from an upstream station (e.g., an eNB or a UE) and send a transmission of the data to a downstream station (e.g., a UE or an eNB). A relay may also be a UE that can relay transmissions for other UEs.

A network controller 50 may couple to a set of eNBs and may provide coordination and control for these eNBs. Network controller 50 may include a single network entity or a collection of network entities. Network controller 50 may communicate with the eNBs via a backhaul. The eNBs may also communicate with one another, e.g., directly or indirectly via a wireless or wireline backhaul.

UEs 40 may be dispersed throughout wireless network 10, and each UE may be stationary or mobile. A UE may also be referred to as a mobile station, a terminal, an access terminal, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a smart phone, a netbook, a smartbook, etc. A UE may be able to communicate with eNBs, relays, etc. A UE may also be able to communicate peer-to-peer (P2P) with other UEs.

Wireless network 10 may support operation on a single carrier or multiple carriers for each of the DL and UL. A carrier may refer to a range of frequencies used for communication and may be associated with certain characteristics. Operation on multiple carriers may also be referred to as multi-carrier operation or carrier aggregation. A UE may operate on one or more carriers for the DL (or DL carriers) and one or more carriers for the UL (or UL carriers) for communication with an eNB. The eNB may send data and control information on one or more DL carriers to the UE. The UE may send data and control information on one or more UL carriers to the eNB. In one design, the DL carriers may be paired with the UL carriers. In this design, control information to support data transmission on a given DL carrier may be sent on that DL carrier and an associated UL carrier. Similarly, control information to support data transmission on a given UL carrier may be sent on that UL carrier and an associated DL carrier. In another design, cross-carrier control may be supported. In this design, control information to support data transmission on a given DL carrier may be sent on another DL carrier (e.g., a base carrier) instead of the given DL carrier.

Wireless network 10 may support carrier extension for a given carrier. For carrier extension, different system bandwidths may be supported for different UEs on a carrier. For example, the wireless network may support (i) a first system bandwidth on a DL carrier for first UEs (e.g., UEs supporting LTE Release 8 or 9 or some other release) and (ii) a second system bandwidth on the DL carrier for second UEs (e.g., UEs supporting a later LTE release). The second system bandwidth may completely or partially overlap the first system bandwidth. For example, the second system bandwidth may include the first system bandwidth and additional bandwidth at one or both ends of the first system bandwidth. The additional system bandwidth may be used to send data and possibly control information to the second UEs.

Wireless network 10 may support data transmission via single-input single-output (SISO), single-input multiple-output (SIMO), multiple-input single-output (MISO), and/or multiple-input multiple-output (MIMO). For MIMO, a transmitter (e.g., an eNB) may transmit data from multiple transmit antennas to multiple receive antennas at a receiver (e.g., a UE). MIMO may be used to improve reliability (e.g., by transmitting the same data from different antennas) and/or to improve throughput (e.g., by transmitting different data from different antennas).

Wireless network 10 may support single-user (SU) MIMO, multi-user (MU) MIMO, Coordinated Multi-Point (CoMP), etc. For SU-MIMO, a cell may transmit multiple data streams to a single UE on a given time-frequency resource with or without precoding. For MU-MIMO, a cell may transmit multiple data streams to multiple UEs (e.g., one data stream to each UE) on the same time-frequency resource with or without precoding. CoMP may include cooperative transmission and/or joint processing. For cooperative transmission, multiple cells may transmit one or more data streams to a single UE on a given time-frequency resource such that the data transmission is steered toward the intended UE and/or away from one or more interfered UEs. For joint processing, multiple cells may transmit multiple data streams to multiple UEs (e.g., one data stream to each UE) on the same time-frequency resource with or without precoding.

Wireless network 10 may support hybrid automatic retransmission (HARQ) in order to improve reliability of data transmission. For HARQ, a transmitter (e.g., an eNB) may send a transmission of a data packet (or transport block) and may send one or more additional transmissions, if needed, until the packet is decoded correctly by a receiver (e.g., a UE), or the maximum number of transmissions has been sent, or some other termination condition is encountered. The transmitter may thus send a variable number of transmissions of the packet.

Wireless network 10 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time.

Wireless network 10 may utilize frequency division duplex (FDD) or time division duplex (TDD). For FDD, the DL and UL may be allocated separate frequency channels, and DL transmissions and UL transmissions may be sent concurrently on the two frequency channels. For TDD, the DL and UL may share the same frequency channel, and DL and UL transmissions may be sent on the same frequency channel in different time periods.

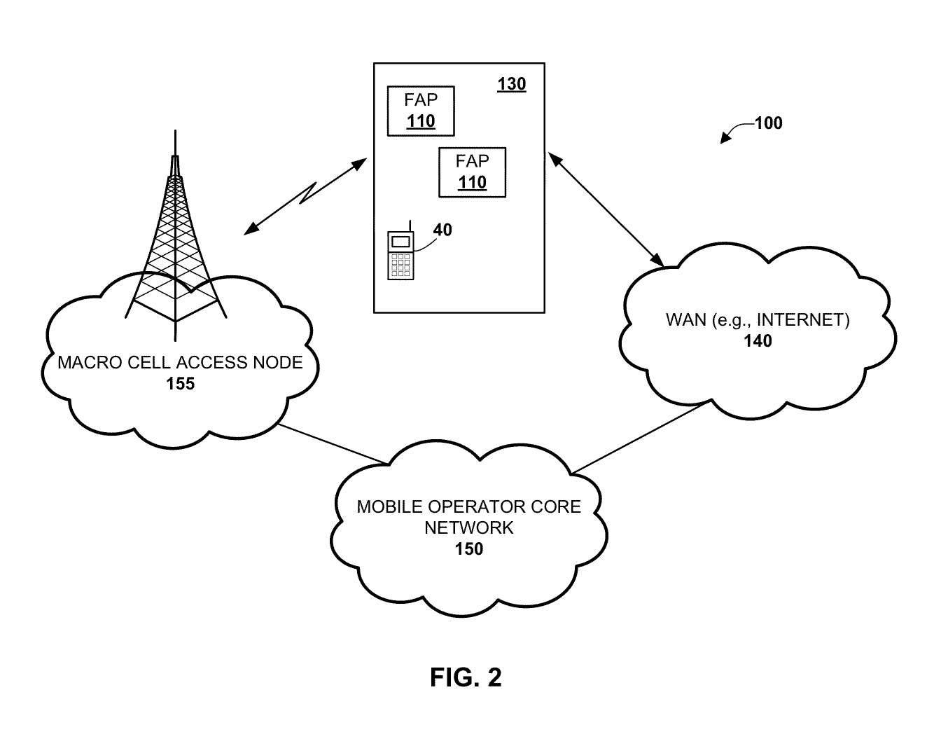

FIG. 2 is an illustration of a planned or semi-planned wireless communication environment 100, in accordance with various aspects. Communication environment 100 includes multiple access point base stations, including FAPs 110, each of which are installed in corresponding small scale network environments. Examples of small scale network environments can include user residences, places of business, indoor/outdoor facilities 130, and so forth. In one aspect, the FAPs 110 can be configured to serve any UEs 40. In another aspect, the FAPs 110 can be configured to serve associated UEs 40 (e.g., included in a CSG associated with FAPs 110), or optionally alien or visitor UEs 40 (e.g., UEs that are not configured for the CSG of the FAP 110). Each FAP 110 is further coupled to a wide area network (WAN) (e.g., the Internet 140) and a mobile operator core network 150 via a DSL router, a cable modem, a broadband over power line connection, a satellite Internet connection, or the like.

To implement wireless services via FAPs 110, in one aspect, an owner of the FAPs 110 subscribes to mobile service offered through the mobile operator core network 150. Also, the UE 40 can be capable to operate in a macro cellular environment and/or in a small scale network environment, utilizing various techniques described herein. Thus, at least in some disclosed aspects, FAP 110 can be backward compatible with any suitable existing UE 40. Furthermore, in addition to the macro cell mobile network 155, UE 40 is served by a predetermined number of FAPs 110, specifically FAPs 110 that reside within a corresponding user residence(s), place(s) of business, or indoor/outdoor facilities 130, and cannot be in a soft handover state with the macro cell mobile network 155 of the mobile operator core network 150. It should be appreciated that although aspects described herein employ 3GPP terminology, it is to be understood that the aspects can also be applied to various technologies, including 3GPP technology (Release 99 [Rel99], Rel5, Rel6, Rel7), 3GPP2 technology (1xRTT, 1xEV-DO Rel0, RevA, RevB), and other known and related technologies.

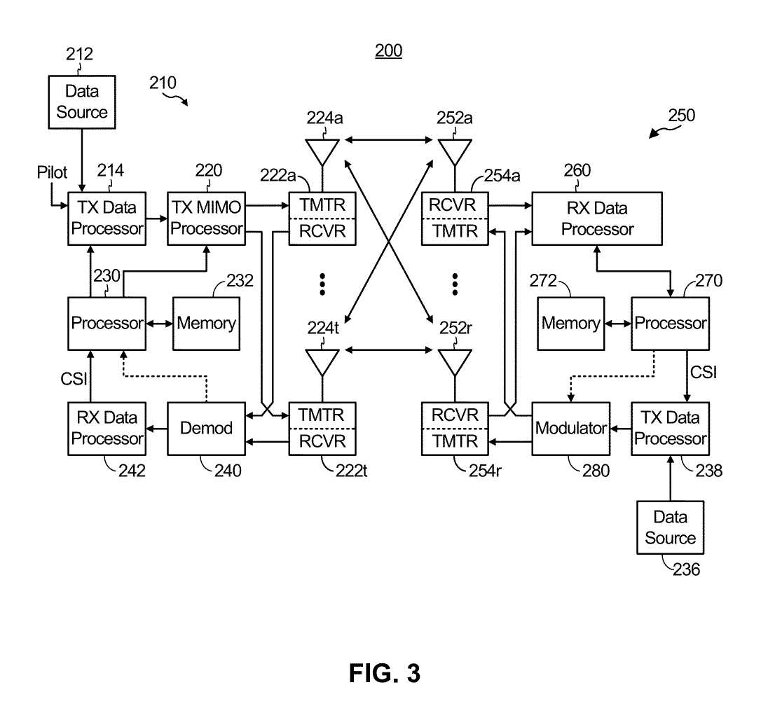

FIG. 3 is a block diagram of an embodiment of a transmitter system 210 (also known as an access point) and a receiver system 250 (also known as a UE or the like) in a MIMO system 200. At the transmitter system 210, traffic data for a number of data streams is provided from a data source 212 to a transmit (TX) data processor 214. In an embodiment, each data stream is transmitted over a respective transmit antenna. The TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., Binary Phase Shift Keying (BPSK), Quadrature Phase Shift Keying (QSPK), M-ary Phase-Shift Keying (M-PSK), or Multi-Level Quadrature Amplitude Modulation (M-QAM)) selected for that data stream to provide modulation symbols. The data rate, coding, and modulation for each data stream may be determined by instructions performed by a processor 230.

The modulation symbols for all data streams may then be provided to a TX MIMO processor 220, which may further process the modulation symbols (e.g., for OFDM). The TX MIMO processor 220 then provides NT modulation symbol streams to NT transmitters (TMTR) 222a through 222t. In certain embodiments, the TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. NT modulated signals from transmitters 222a through 222t are then transmitted from NT antennas 224a through 224t, respectively.

At the receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from the NR receivers 254 based on a particular receiver processing technique to provide NT “detected” symbol streams. The RX data processor 260 then demodulates, deinterleaves, and decodes each detected symbol stream to recover the traffic data for the data stream. The processing by the RX data processor 260 is complementary to that performed by the TX MIMO processor 220 and the TX data processor 214 at the transmitter system 210.

A processor 270 periodically determines which pre-coding matrix to use, discussed further below. The processor 270 formulates a reverse link message comprising a matrix index portion and a rank value portion. The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to the transmitter system 210.

At the transmitter system 210, the modulated signals from the receiver system 250 are received by the antennas 224, conditioned by the receivers 222, demodulated by a demodulator 240, and processed by a RX data processor 242 to extract the reserve link message transmitted by the receiver system 250. The processor 230 then determines which pre-coding matrix to use for determining the beamforming weights then processes the extracted message.

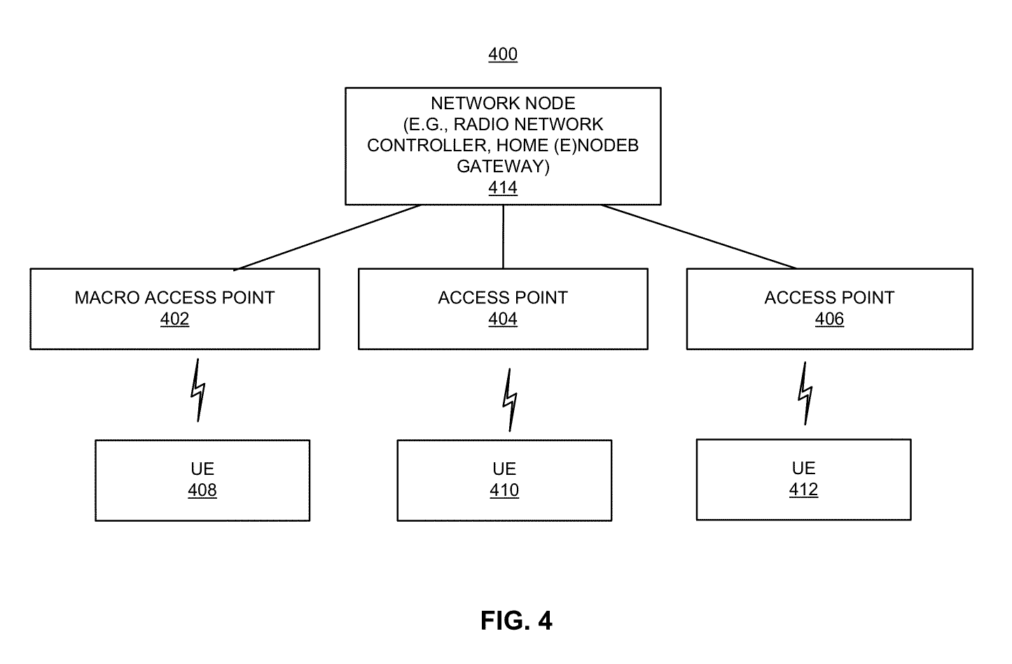

FIG. 4 illustrates sample aspects of a communication system 400 where distributed nodes (e.g., access points 402, 404, and 406) provide wireless connectivity for other nodes (e.g., UEs 408, 410, and 412) that may be installed in or that may roam throughout an associated geographical area. In some aspects, the access points 402, 404, and 406 may communicate with one or more network nodes (e.g., a centralized network controller such as network node 414) to facilitate WAN connectivity.

In one aspect, an access point, such as access point 404, may be restricted whereby only certain mobile entities (e.g., UE 410) are allowed to access the access point, or the access point may be restricted in some other manner. In such a case, a restricted access point and/or its associated mobile entities (e.g., UE 410) may interfere with other nodes in the system 400 such as, for example, an unrestricted access point (e.g., macro access point 402), its associated mobile entities (e.g., UE 408), another restricted access point (e.g., access point 406), or its associated mobile entities (e.g., UE 412). For example, the closest access point to a given UE may not be the serving access point for the given UE. Consequently, transmissions by the given UE may interfere with reception at another UE that is being served by the access point that is closed to the given UE. Frequency reuse, frequency selective transmission, interference cancellation and smart antenna (e.g., beamforming and null steering) and other techniques may be employed to mitigate interference.

In another aspect, an access point, such as access point 404, may allow all mobile entities (e.g., UE 410) to access the access point. In such a case, interference concerns explained above are reduced. In one example, such an access point may be located inside a building but provide service to mobile entities (e.g., UE 410) located outside the building.

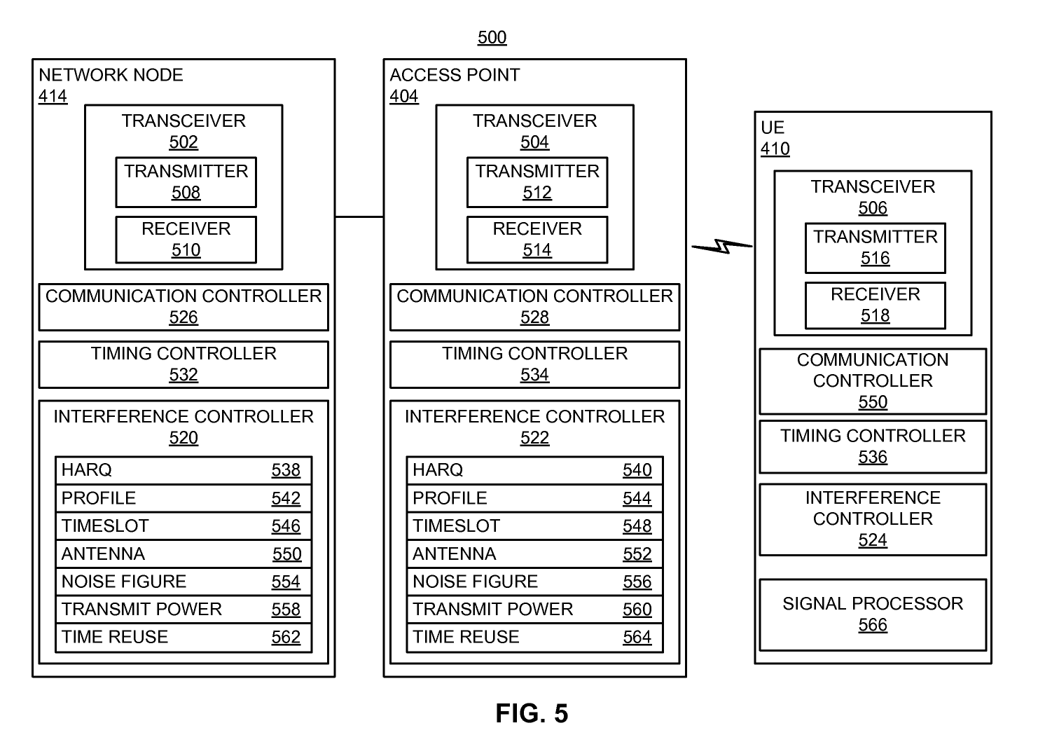

FIG. 5 illustrates several sample components that may be incorporated into the network node 414 (e.g., a radio network controller), the access point 404, and the UE 410 in accordance with the teachings herein. It should be appreciated that the components illustrated for a given one of these nodes also may be incorporated into other nodes in the system 500.

The network node 414, the access point 404, and the UE 410 include transceivers 502, 504, and 506, respectively, for communicating with each other and with other nodes. The transceiver 502 includes a transmitter 508 for sending signals and a receiver 510 for receiving signals. The transceiver 504 includes a transmitter 512 for transmitting signals and a receiver 514 for receiving signals. The transceiver 506 includes a transmitter 516 for transmitting signals and a receiver 518 for receiving signals.

In a typical implementation, the access point 404 communicates with the UE 410 via one or more wireless communication links and the access point 404 communicates with the network node 414 via a backhaul. It should be appreciated that wireless or non-wireless links may be employed between these nodes or other in various implementations. Hence, the transceivers 502, 504, and 506 may include wireless and/or non-wireless communication components.

The network node 414, the access point 404, and the UE 410 also include various other components that may be used in conjunction with interference management as taught herein. For example, the network node 414, the access point 404, and the UE 410 may include interference controllers 520, 522, and 524, respectively, for mitigating interference and for providing other related functionality as taught herein. The interference controller 520, 522, and 524 may include one or more components for performing specific types of interference management. The network node 414, the access point 404, and the UE 410 may include communication controllers 526, 528, and 550, respectively, for managing communications with other nodes and for providing other related functionality as taught herein. The network node 414, the access point 404, and the UE 410 may include timing controllers 532, 534, and 536, respectively, for managing communications with other nodes and for providing other related functionality as taught herein. The other components illustrated in FIG. 5 will be discussed in the disclosure that follows.

For illustrative purposes, the interference controllers 520 and 522 are depicted as including several controller components. In practice, however, a given implementation may not employ all of these components. Here, a hybrid automatic repeat request (HARQ) controller component 538 or 540 may provide functionality relating to HARQ interlace operations as taught herein. A profile controller component 542 or 544 may provide functionality relating to transmit power profile or receive attenuation operations as taught herein. A timeslot controller component 546 or 548 may provide functionality relating to timeslot portion operations as taught herein. An antenna controller component 550 or 552 may provide functionality relating to smart antenna (e.g., beamforming and/or null steering) operations as taught herein. A receive noise controller component 554 or 556 may provide functionality relating to adaptive noise figure and PL adjustment operations as taught herein. A transmit power controller component 558 or 560 may provide functionality relating to transmit power operations as taught herein. A time reuse controller component 562 or 564 may provide functionality relating to time reuse operations as taught herein.

FIG. 4 illustrates how the network node 414, the access point 404, and the UE 410 may interact with one another to provide interference management (e.g., interference mitigation). In some aspects, these operations may be employed on an UL and/or on a DL to mitigate interference. In accordance with one or more embodiments of the present disclosure, there are provided techniques for sharing of backhaul bandwidth by multiple femtocells in order to mitigate issues that can result from a single femtocell reaching its backhaul capacity limitation. Total throughput and/or number of users supported by a Femtocell, may become limited due to its limited backhaul capacity. This may create undesirable situations for backhaul limited femtocell such as limiting maximum throughput of its existing users, impacting their user experience. Backhaul limited femtocells may also reject service to a new user or re-direct it to a less preferred cell, where rejecting/re-directing a user may increase the user's call setup delay, and re-directing the user to a less preferred cell may cause the user to be on a cell with worse channel quality and/or non-preferred billing rates and/or fewer services (for e.g., a user re-directed to a macrocell may not get its femtocell-specific services such as home networking, LIPA, etc.). Moreover, if backhaul bandwidth is not shared by multiple femtocells, it would lead to non-optimal use of the total available bandwidth. That is, while some of the femtocells may become backhaul limited, their neighboring or other femtocells may not be fully using their backhaul bandwidth. Variability in backhaul capacity of femtocells may happen due to a number of reasons including, for example, different femtocells may have different backhaul capacity and may use it at a different time of the day; different customers may subscribe for different backhaul capacity depending on their usage and budget; a femtocell deployed indoors using customer backhaul may have lower backhaul capacity than a femtocell deployed outdoors by an operator with dedicated backhaul.

To mitigate these and other issues, a backhaul bandwidth constrained femtocell may use its radio resources/capacity, if available, to direct/relay some of its traffic to another femtocell in order to use the other femtocell's available backhaul bandwidth. Radio resources/capacity used by the femtocell for this purpose may be of any technology such as WCDMA/HSPA, LTE, WiFi, etc. Moreover, femtocells may either use their backhaul resources or radio resources to negotiate sharing of their backhaul bandwidth/resources. To know whether the femtocell is bandwidth constrained or not, a femtocell may monitor its available backhaul bandwidth. This may be done by in a number of ways such as active probing or monitoring the success of uplink packets, checking queuing delays of packets at the femtocell, etc. If the available backhaul bandwidth at the femtocell is less than the required bandwidth, the femtocell may check if any of the neighboring femtocells would be able to provide/share their bandwidth. Such communication between femtocells may happen over the air or over the backhaul. If one or more neighboring femtocells may provide/share their bandwidth, the femtocell may select a subset of these neighboring femtocells for using their bandwidth. The selection of these neighboring femtocells may be based on things such as capabilities, the bandwidth available, proximity to the current femtocell, access restrictions, channel conditions, and proximity to the served users. Once a neighboring femtocell has been selected for bandwidth sharing, the current femtocell may act as one of the clients, user, or UE of the neighboring femtocell and send the data to the neighboring femtocell. The sent data could be the data of current femtocell users or data related to the femtocell itself or data of users of some other femtocell.

Use cases or triggers for backhaul bandwidth sharing are provided below. In a first use case: the backhaul limited femtocell uses another femtocell's backhaul to momentarily increase its backhaul bandwidth to accept a new user, which it otherwise would have rejected or re-directed or could not have served due to lack of its backhaul resources, and then after some time may hand it over to another cell (to avoid call setup delay). In a second use case: the femtocell prioritizes use of its own bandwidth for some of its users, and uses other femtocell's backhaul for its other users. This could be the femtocell's normal behavior or behavior when it becomes backhaul limited. Such prioritized users may be:

a. users using femto-specific services such as home networking;

b. voice users or users requiring guaranteed bit rate (or better quality of service (QoS)); or

c. users which are the member of the Femtocell's closed subscriber group (CSG) ID.

In accordance with another one or more embodiments of the present disclosure, there are provided techniques for backhaul management of femtocells. Specifically, a provider of backhaul bandwidth may notice the variation in usage of backhaul bandwidth by the femtocell at different times of the day and may use it to vary the amount of bandwidth provided to that femtocell at a particular time of the day. For example, if the femtocell bandwidth usage is low during the day time but high during the night time, the provider may provide less bandwidth to that femtocell during the day time but may increase the bandwidth during the night time.

Also, the provider may increase or decrease backhaul bandwidth provided to each femtocell depending on its average usage over a period of time. For example, if backhaul bandwidth usage by a femtocell remains high for a week, then the provider may decide to increase its backhaul bandwidth. Similarly, the available femtocell bandwidth may be decreased if its average usage continues to be low for a period of time. The femtocell's backhaul bandwidth usage may either be detected by the provider itself or could be provided by the femtocell either directly or through another entity.

Backhaul sharing may be facilitated by connectivity speed and capacity broadcasts from femtocells. For example, a femtocell may advertise its backhaul connectivity speed fbᵢ and a current percentage utilization of backhaul fubᵢ. The advertisements may be communicated over the air (e.g., through Wi-Fi) or communicated over a wireline (e.g., Ethernet). In one example, 802.11u supports Access Network Query Protocol (ANQP) which may provide a range of information such as the network authentication types supported, venue name, roaming agreements in place, throughput of the backhaul link, well-known port numbers that are open, etc.

Neighboring femtocells may pool together their share of backhaul connectivity. Pooling together the resources may include cooperation of a broadband service provider. Advantages associated with pool resources may be realized if the broadband service provider is providing wireless services. An underutilized femtocell may make available or “lease” the femtocell's share of backhaul to over-utilized femtocells for a period of time (e.g., a predetermined or configured period of time) to enhance a quality of experience (QoE). An aggregate backhaul connectivity may be defined as SUMMATIONᵢ [fbᵢ] where fbᵢ is the advertised backhaul speed of the i^{th} femtocell. Aggregate backhaul utilization is (SUMMATIONᵢ [fbuᵢ*fbᵢ])/(SUMMATIONᵢ [fbᵢ]), where fbuᵢ is the percentage utilization of backhaul of the i^{th} femtocell. Some femtocells may not have their own dedicated backhaul. Backhaul sharing or distributed backhaul schemes may be advantageous in these instances.

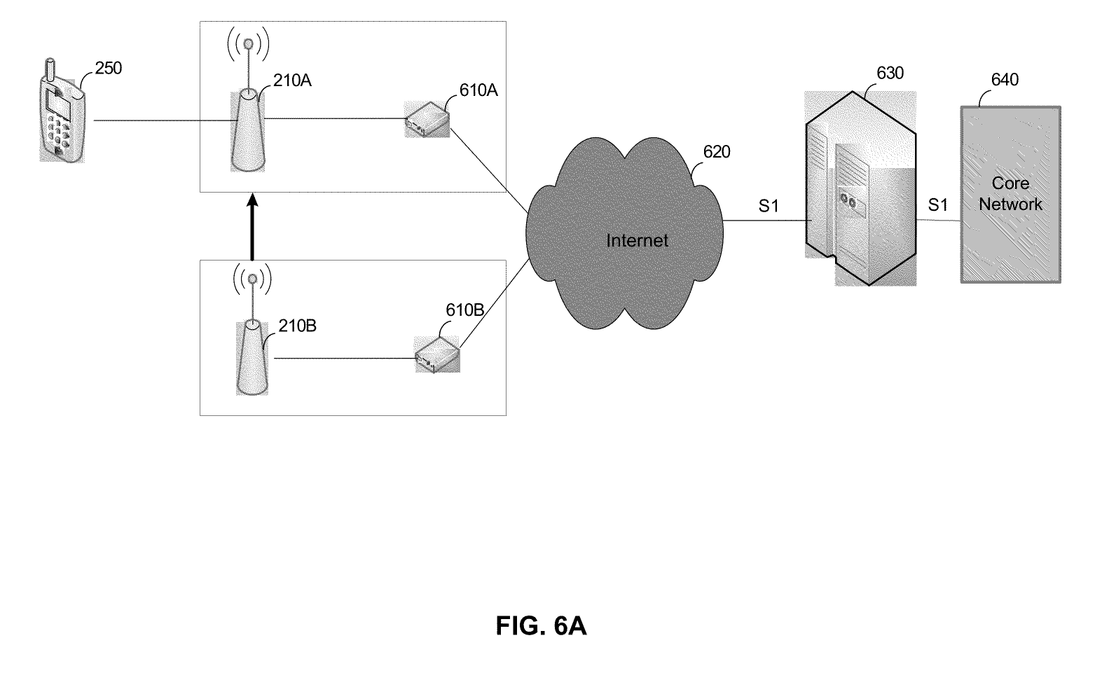

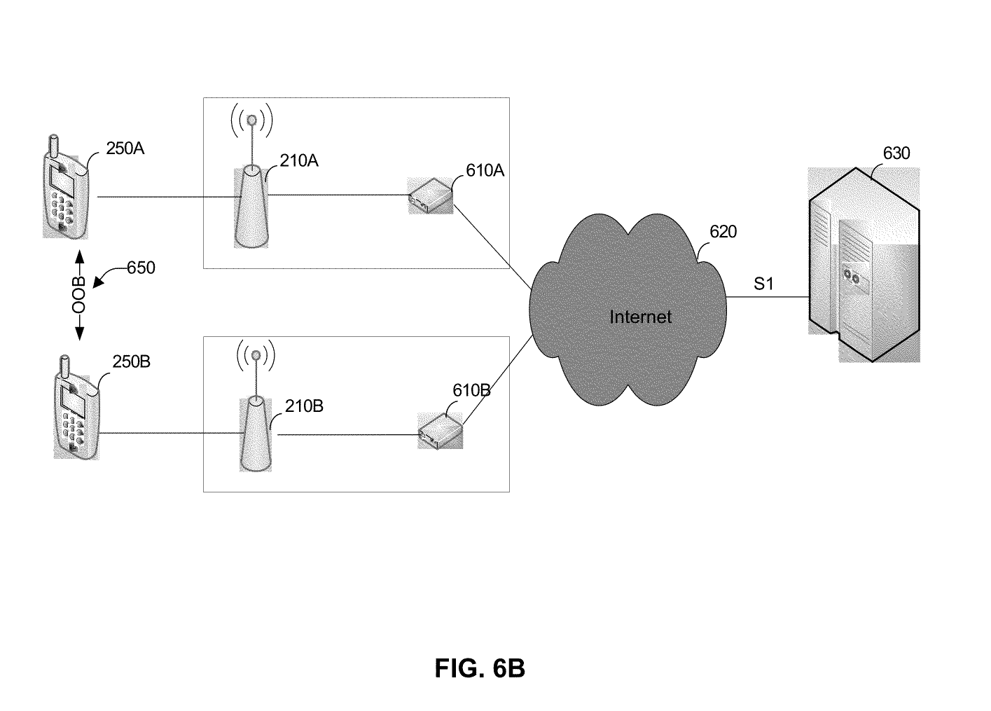

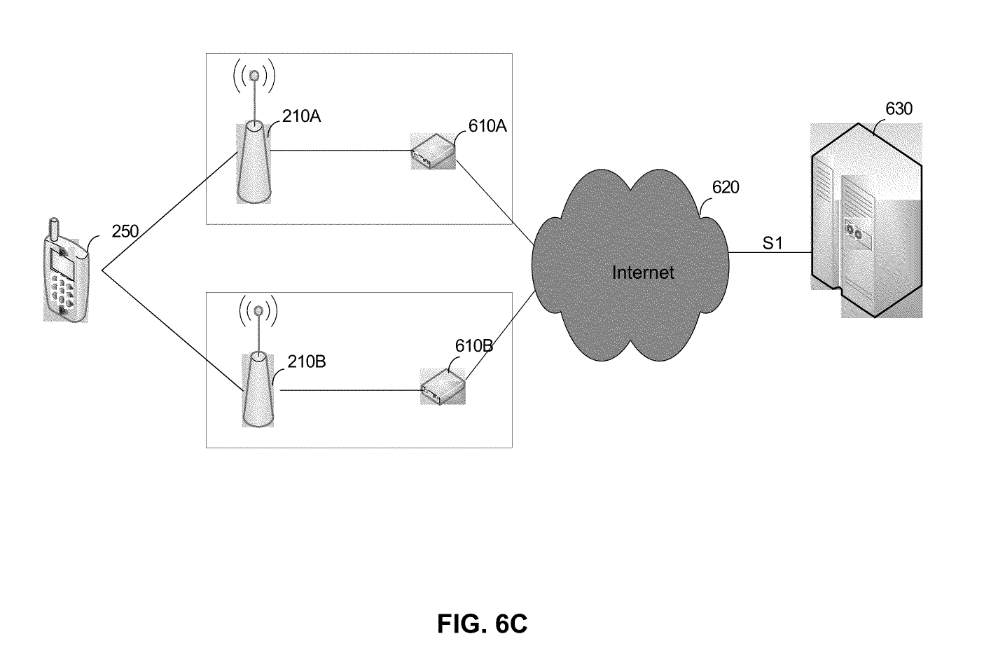

FIGS. 6A-C illustrate example wireless communication environments configured for backhaul sharing. FIGS. 6A-C may illustrate backhaul sharing models. FIG. 6A illustrates a wireless communication environment including a UE 250 connected to a femtocell 210A. The femtocell 210A may be coupled to the Internet 620 via a broadband modem 610A. Another femtocell 210B (e.g., a femtocell in the vicinity of femtocell 210A) may be coupled to the Internet 620 via a broadband modem 610A. Femtocells 210A, 210B may be connected to the core network via a femtocell gateway FGW 630. The FGW communicates with the femtocells 210A, 210B via the Internet 620 through the S1 interface. The FGW may communicate with the core network 640 via the S1 interface. Femtocell 210B may advertise its backhaul connectivity speed fbᵢ and a current percentage utilization of backhaul fubᵢ. For example, femtocells 210A, 210B may communicate via any of LTE D2D over licensed spectrum or White Space, Wi-Fi Direct, or Wi-Fi. In the example, of FIG. 6A, when the connection between the UE 250 and femtocell 210A is not bottlenecked or constrained by the available backhaul bandwidth of femtocell 210A, backhaul sharing may not be necessary. When the connection is constrained or when more bandwidth is desired, femtocell 210B may lease its share (in part of in its entirety) of backhaul to femtocell 210A. The effective available backhaul bandwidth may be a bandwidth up to the sum of the bandwidths for femtocell 210A and femtocell 210B.

One femtocell (e.g., 210A) may still continue to control a UE (e.g., 250) for example, to keep the control plane of the UE with the femtocell, and only switch the user plane of the UE to another femtocell (e.g., 210B). Keeping the control plane of the UE may allow the femtocell to manage radio resources of the UE, change femtocells at which the UE's traffic or user plane should come from, and handover the UE, if required.

Switching of the user plane to a neighboring femtocell may be done using RANAP/RNSAP procedures in UMTS (3GPP TS 25.413, TS 25.423). For example, RANAP's Relocation Procedure may be used. Such switching of the user plane may also be done using S1AP/X2AP procedures in LTE (3GPP TS 36.413, TS 36.423). For example, S1AP's “Path Switch Request” message may be used. It may also be possible to have part of the same UE traffic coming or going over one femtocell's (e.g., 210A) backhaul and another femtocell's (e.g., 210B) backhaul simultaneously.

FIG. 6B illustrates another wireless communication environment including UEs 250A, 250B connected to femtocells 210A, 210B, respectively. An out of band (OOB) link may be activated between the UEs 250A, 250B. The OOB link may be a wireless link such as Bluetooth, Wi-Fi, Wi-Fi Direct, LTE D2D, etc. UE 250A may desire additional bandwidth and/or the backhaul bandwidth of femtocell 210A is constrained. UE 250B may assist in providing additional bandwidth. For example, the bandwidth of femtocell 210B may be provided via UE 250B.

FIG. 6C illustrates yet another wireless communication environment including UE 250 connected to femtocells 210A, 210B. The UE 250 may connect to two different femtocells at the same time (e.g., simultaneously) for flow aggregation. The data flow may be directed to femtocells 210A, 210B.

In another embodiment, a traffic management node may restrain from counting data flow against a user's account. In one example, data flow from a user may not be counted based on a set of criteria. When the data is transmitted via a femtocell, the data flow is not counted against the user's throughput or capacity limit. For example, for data transmitted to or from a femtocell and transmitted to or from an internet service provider (ISP) account holder's device, the data flow is not counted against the user's throughput or capacity limit. For data transmitted to or from a femtocell and transmitted to or from another user, the data flow is not counted against the user's throughput or capacity limit. A node may determine an IP flow terminates in a femtocell based on IP flow terminating at a particular node (e.g., HNB-GW, HeNB-GW, MME, etc).

In another example, when data is transmitted via a femtocell, the data flow is not counted against the user's throughput or capacity limit when users other than the ISP account holder are server. For example, for data transmitted to or from a femtocell and transmitted to or from an internet service provider (ISP) account holder's device, the data flow is counted against the user's throughput or capacity limit. For data transmitted to or from a femtocell and transmitted to or from another user, the data flow is not counted against the user's throughput or capacity limit. A node may determine the IP flow belongs to other users based on a) the femtocell, H(e)NB, MME, or PCRF informing the backhaul provider's GW for each flow, b) based on inspection (RANAP/SA1AP/etc.) by the backhaul provider's GW, or c) an address of the source or destination in the core network.

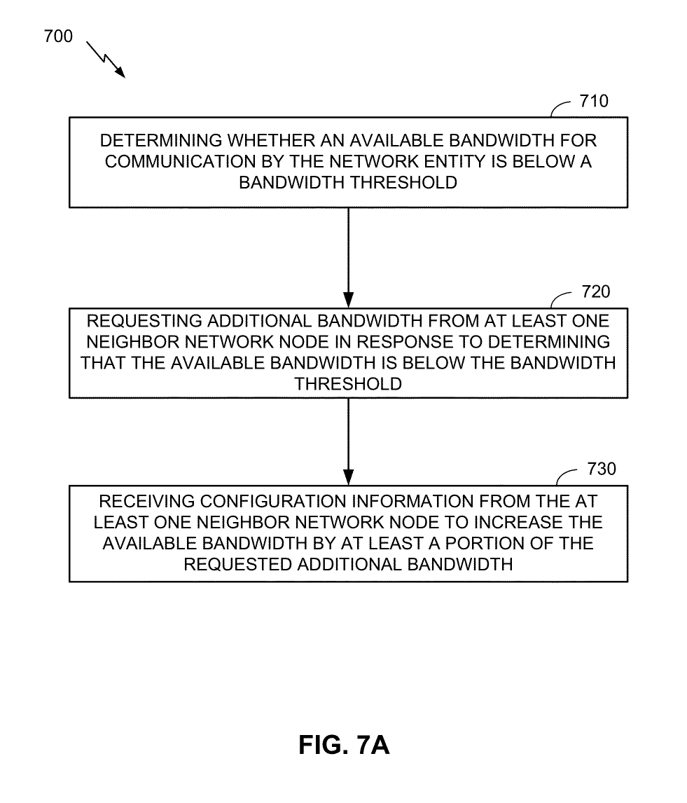

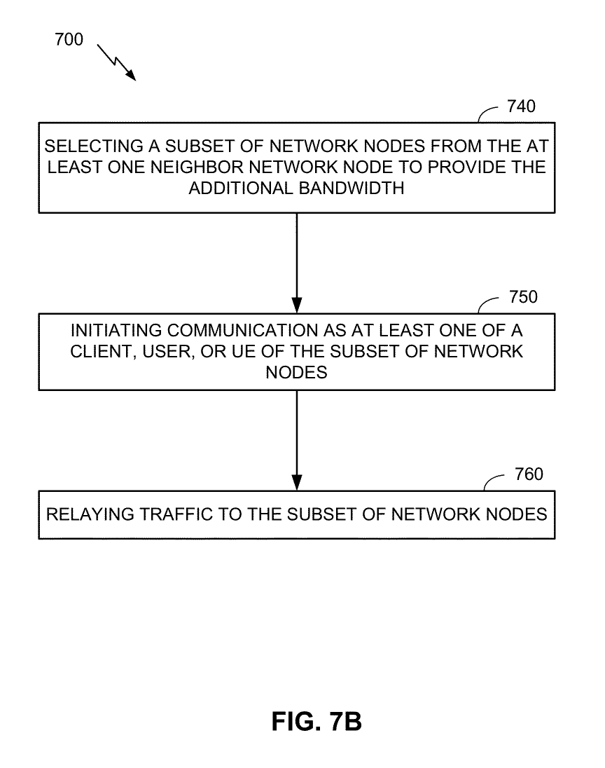

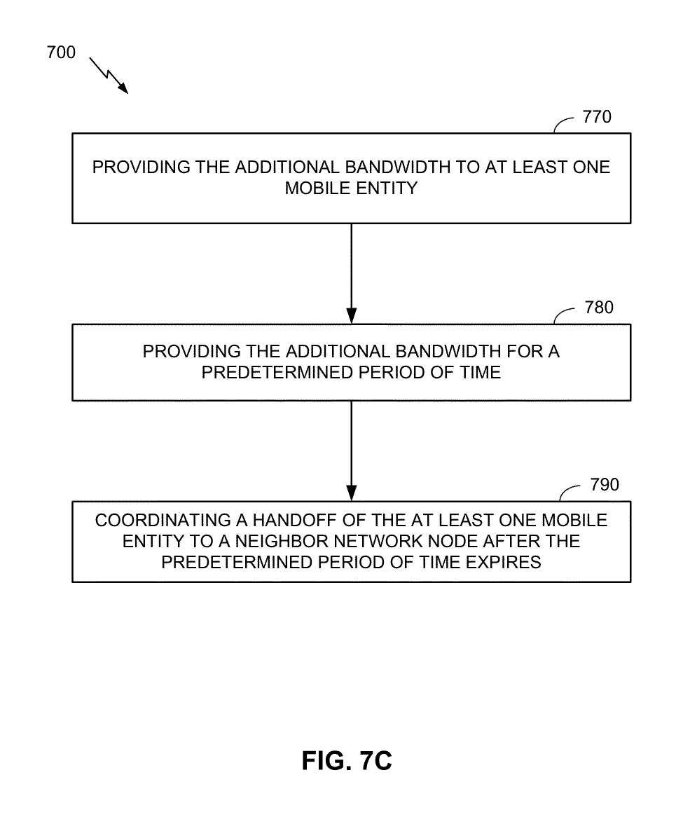

In accordance with one or more aspects of the embodiments described herein, with reference to FIG. 7A, there is shown a methodology 700, operable by a network entity, such as, for example, a femtocell, a macrocell, a picocell, or the like. Specifically, method 700 describes a way to share backhaul bandwidth by femtocells. The method 700 may involve, at 710, determining whether an available bandwidth for communication by the network entity is below a bandwidth threshold. The method 700 may involve, at 720, requesting additional bandwidth from at least one neighbor network node in response to determining that the available bandwidth is below the bandwidth threshold. Further, the method may involve, at 730, receiving configuration information from the at least one neighbor network node to increase the available bandwidth by at least a portion of the requested additional bandwidth.

With reference to FIG. 7B, there are shown further operations or aspects of the method 700 that are optional and may be performed by a network entity or the like. If the method 700 includes at least one block of FIG. 7A, then the method 700 may terminate after the at least one block, without necessarily having to include any subsequent downstream block(s) that may be illustrated. It is further noted that numbers of the blocks do not imply a particular order in which the blocks may be performed according to the method 700. For example, the method 700 may further include selecting a subset of network nodes from the at least one neighbor network node to provide the additional bandwidth (block 740), initiating communication as at least one of a client, user, or UE of the subset of network nodes (block 750), and relaying traffic to the subset of network nodes (block 760).

With reference to FIG. 7C, there are shown yet further operations or aspects of the method 700 that are optional and may be performed by a network entity or the like. For example, the method 700 may further include providing the additional bandwidth to at least one mobile entity (block 770), providing the additional bandwidth for a predetermined period of time (block 780), and coordinating a handoff of the at least one mobile entity to a neighbor network node after the predetermined period of time expires (block 790). Yet further operations or aspects of the method 700 are possible. For example, the method may include maintaining, at the network entity, at least one control plane of at least one mobile entity; and switching at least one user plane of the at least one mobile entity to the at least one neighbor network node.

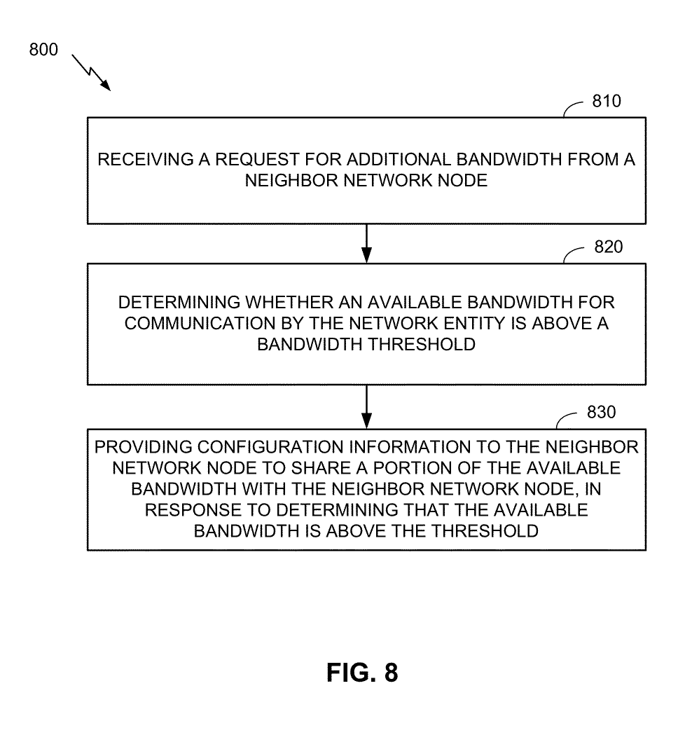

In accordance with one or more aspects another one of the embodiments described herein, with reference to FIG. 8, there is shown a methodology 800, operable by a network entity, such as, for example, a femtocell, a macrocell, a picocell, or the like. Specifically, method 800 describes a way to share backhaul bandwidth by femtocells. The method 800 may involve, at 810, receiving a request for additional bandwidth from a neighbor network node. The method 800 may involve, at 820, determining whether an available bandwidth for communication by the network entity is above a bandwidth threshold. Further, the method may involve, at 830, providing configuration information to the neighbor network node to share a portion of the available bandwidth with the neighbor network node, in response to determining that the available bandwidth is above the threshold.

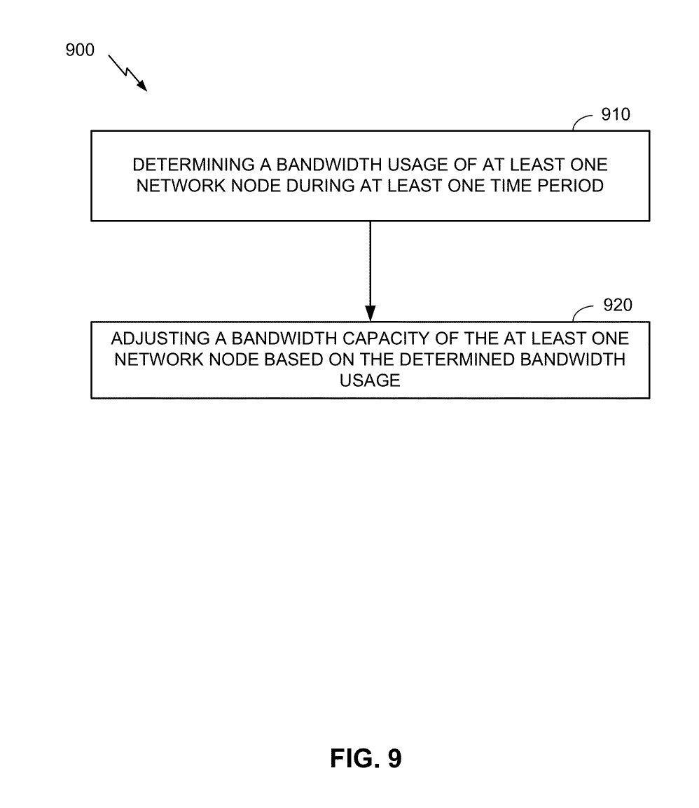

In accordance with one or more aspects of yet another one of the embodiments described herein, with reference to FIG. 9, there is shown a methodology 900, operable by a network entity, such as, for example, a bandwidth provider, femtocell gateway, or core network entity. Specifically, method 900 describes a way to manage backhaul bandwidth for femtocells. The method 900 may involve, at 910, determining a bandwidth usage of at least one network node during at least one time period. The method 900 may involve, at 920, adjusting a bandwidth capacity of the at least one network node based on the determined bandwidth usage.

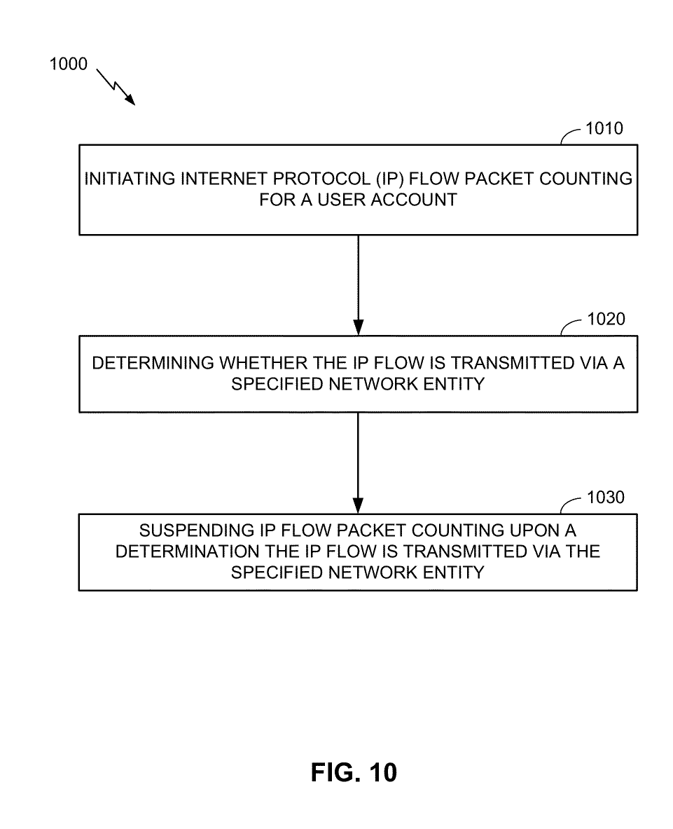

In accordance with one or more aspects another one of the embodiments described herein, with reference to FIG. 10, there is shown a methodology 1000, operable by a network entity, such as, traffic management node. Specifically, method 1000 describes a way to control IP flow packet counting. The method 1000 may involve, at 1010, initiating internet protocol (IP) flow packet counting for a user account. The method 1000 may involve, at 1020, determining whether the IP flow is transmitted via a specified network entity. Further, the method may involve, at 1030, suspending IP flow packet counting upon a determination the IP flow is transmitted via the specified network entity.

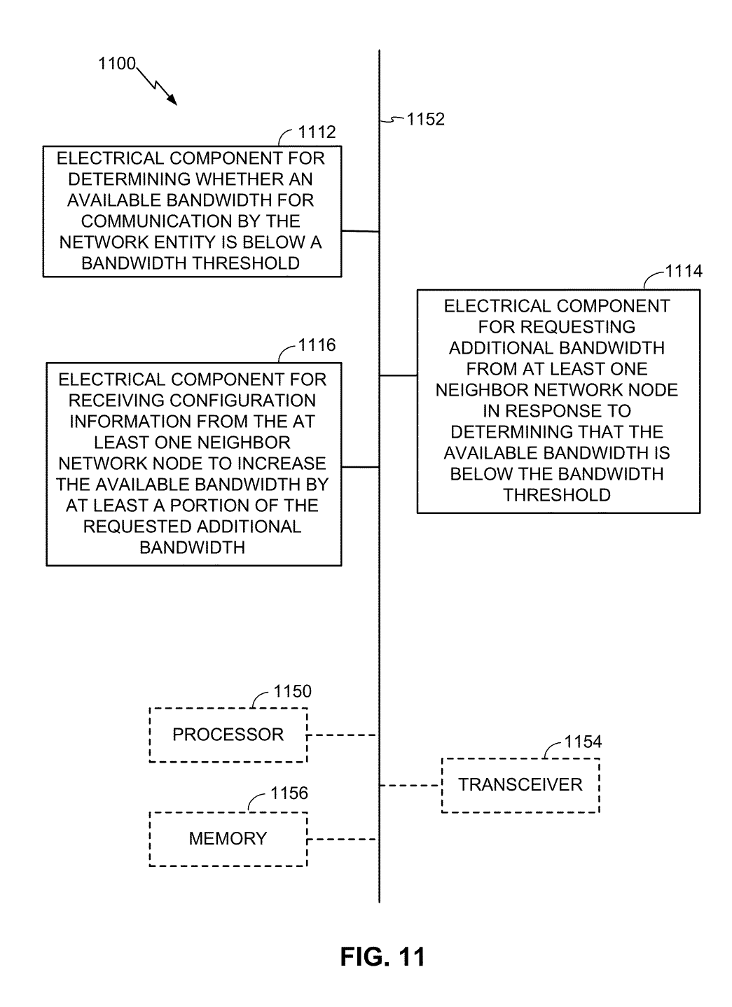

FIG. 11 shows an embodiment of an apparatus for backhaul sharing by femtocells, in accordance with the methodology of FIG. 7A. With reference to FIG. 11, there is provided an exemplary apparatus 1100 that may be configured as a network entity (e.g., a femtocell, a macrocell, a picocell, or the like) in a wireless network, or as a processor or similar device/component for use within the network entity. The apparatus 1100 may include functional blocks that can represent functions implemented by a processor, software, or combination thereof (e.g., firmware). For example, apparatus 1100 may include an electrical component or module 1112 for determining whether an available bandwidth for communication by the network entity is below a bandwidth threshold. The apparatus 1100 may also include a component 1114 for requesting additional bandwidth from at least one neighbor network node in response to determining that the available bandwidth is below the bandwidth threshold. The apparatus 1100 may also include a component 1116 for receiving configuration information from the at least one neighbor network node to increase the available bandwidth by at least a portion of the requested additional bandwidth.

In related aspects, the apparatus 1100 may optionally include a processor component 1150 having at least one processor, in the case of the apparatus 1100 configured as a network entity (e.g., a femtocell, a macrocell, a picocell, or the like), rather than as a processor. The processor 1150, in such case, may be in operative communication with the components 1112-1116 via a bus 1152 or similar communication coupling. The processor 1150 may effect initiation and scheduling of the processes or functions performed by electrical components 1112-1116.

In further related aspects, the apparatus 1100 may include a radio transceiver component 1154. A stand alone receiver and/or stand alone transmitter may be used in lieu of or in conjunction with the transceiver 1154. When the apparatus 1100 is a network entity, the apparatus 1100 may also include a network interface (not shown) for connecting to one or more core network entities. The apparatus 1100 may optionally include a component for storing information, such as, for example, a memory device/component 1156. The computer readable medium or the memory component 1156 may be operatively coupled to the other components of the apparatus 1100 via the bus 1152 or the like. The memory component 1156 may be adapted to store computer readable instructions and data for effecting the processes and behavior of the components 1112-1116, and subcomponents thereof, or the processor 1150, or the methods disclosed herein. The memory component 1156 may retain instructions for executing functions associated with the components 1112-1116. While shown as being external to the memory 1156, it is to be understood that the components 1112-1116 can exist within the memory 1156. It is further noted that the components in FIG. 11 may comprise processors, electronic devices, hardware devices, electronic sub-components, logical circuits, memories, software codes, firmware codes, etc., or any combination thereof.

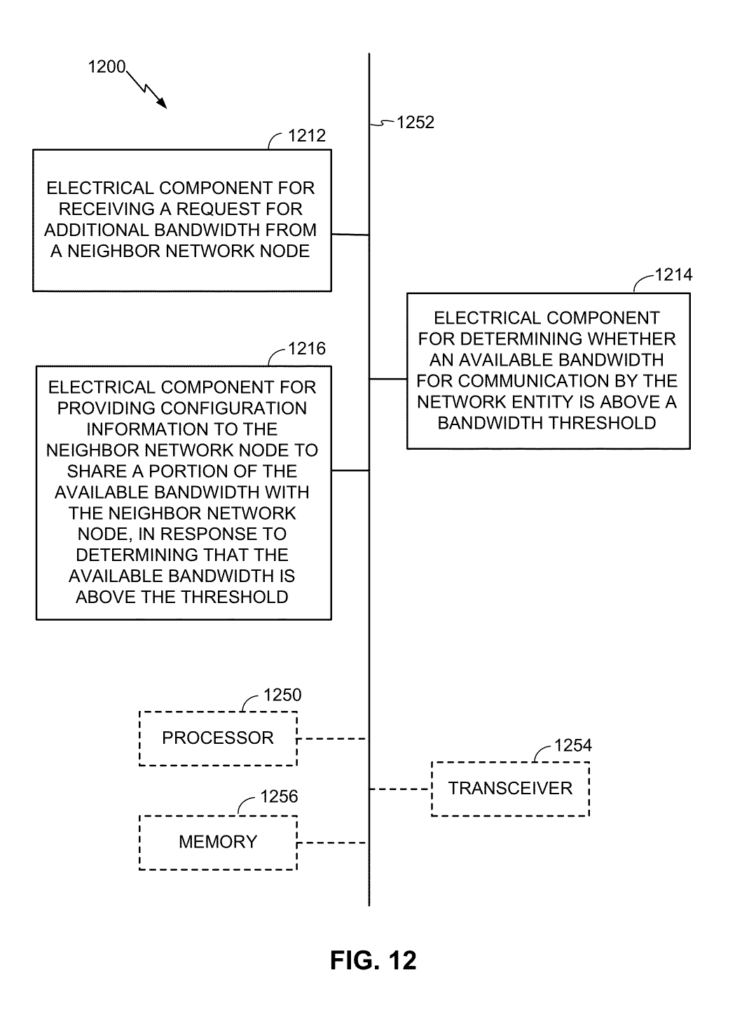

FIG. 12 shows another embodiment of an apparatus for backhaul sharing by femtocells, in accordance with the methodology of FIG. 8. With reference to FIG. 12, there is provided an exemplary apparatus 1200 that may be configured as a network entity (e.g., a femtocell, a macrocell, a picocell, or the like) in a wireless network, or as a processor or similar device/component for use within the network entity. The apparatus 1200 may include functional blocks that can represent functions implemented by a processor, software, or combination thereof (e.g., firmware). For example, apparatus 1200 may include an electrical component or module 1212 for receiving a request for additional bandwidth from a neighbor network node. The apparatus 1200 may also include a component 1214 for determining whether an available bandwidth for communication by the network entity is above a bandwidth threshold. The apparatus 1200 may also include a component 1216 for providing configuration information to the neighbor network node to share a portion of the available bandwidth with the neighbor network node, in response to determining that the available bandwidth is above the threshold.

In related aspects, the apparatus 1200 may optionally include a processor component 1250 having at least one processor, in the case of the apparatus 1200 configured as a network entity (e.g., a femtocell, a macrocell, a picocell, or the like), rather than as a processor. The processor 1250, in such case, may be in operative communication with the components 1212-1216 via a bus 1252 or similar communication coupling. The processor 1250 may effect initiation and scheduling of the processes or functions performed by electrical components 1212-1216.

In further related aspects, the apparatus 1200 may include a radio transceiver component 1254. A stand alone receiver and/or stand alone transmitter may be used in lieu of or in conjunction with the transceiver 1254. When the apparatus 1200 is a network entity, the apparatus 1200 may also include a network interface (not shown) for connecting to one or more core network entities. The apparatus 1200 may optionally include a component for storing information, such as, for example, a memory device/component 1256. The computer readable medium or the memory component 1256 may be operatively coupled to the other components of the apparatus 1200 via the bus 1252 or the like. The memory component 1256 may be adapted to store computer readable instructions and data for effecting the processes and behavior of the components 1212-1216, and subcomponents thereof, or the processor 1250, or the methods disclosed herein. The memory component 1256 may retain instructions for executing functions associated with the components 1212-1216. While shown as being external to the memory 1256, it is to be understood that the components 1212-1216 can exist within the memory 1256. It is further noted that the components in FIG. 12 may comprise processors, electronic devices, hardware devices, electronic sub-components, logical circuits, memories, software codes, firmware codes, etc., or any combination thereof.

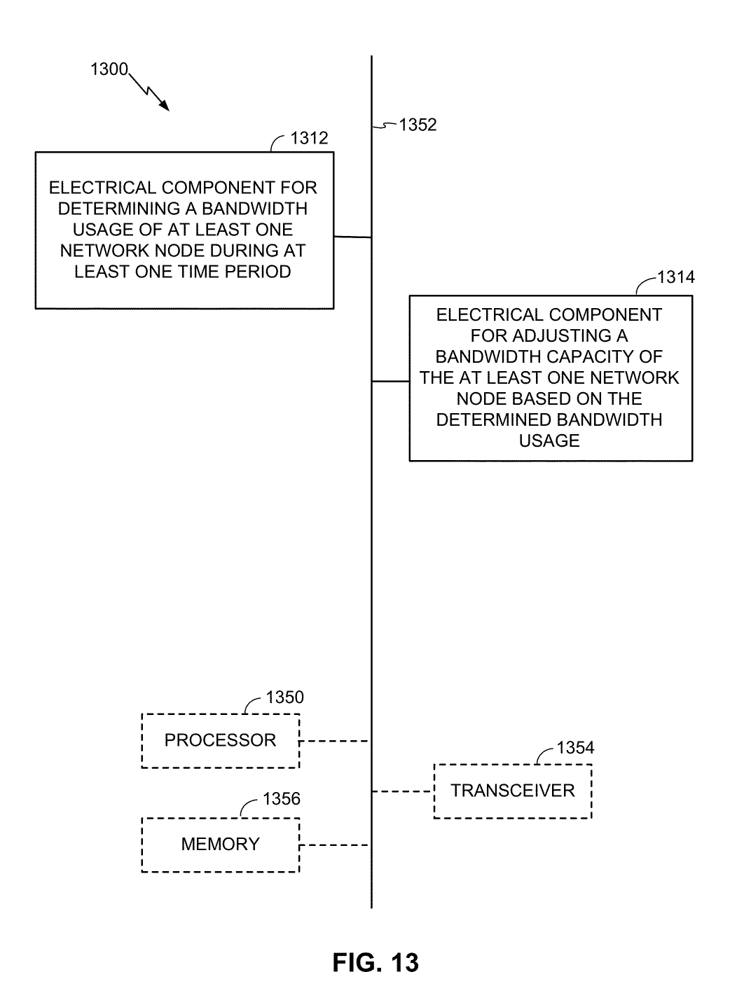

FIG. 13 shows yet another embodiment of an apparatus for backhaul management of femtocells, in accordance with the methodology of FIG. 9. With reference to FIG. 13, there is provided an exemplary apparatus 1300 that may be configured as a network entity (e.g., a bandwidth provider, femtocell gateway, or core network entity, or the like) in a wireless network, or as a processor or similar device/component for use within the network entity. The apparatus 1300 may include functional blocks that can represent functions implemented by a processor, software, or combination thereof (e.g., firmware). For example, apparatus 1300 may include an electrical component or module 1312 for determining a bandwidth usage of at least one network node during at least one time period. The apparatus 1300 may also include a component 1314 for adjusting a bandwidth capacity of the at least one network node based on the determined bandwidth usage.

In related aspects, the apparatus 1300 may optionally include a processor component 1350 having at least one processor, in the case of the apparatus 1300 configured as a network entity (e.g., a femtocell, a macrocell, a picocell, or the like), rather than as a processor. The processor 1350, in such case, may be in operative communication with the components 1312-1314 via a bus 1352 or similar communication coupling. The processor 1350 may effect initiation and scheduling of the processes or functions performed by electrical components 1312-1314.

In further related aspects, the apparatus 1300 may include a radio transceiver component 1354. A stand alone receiver and/or stand alone transmitter may be used in lieu of or in conjunction with the transceiver 1354. When the apparatus 1300 is a network entity, the apparatus 1300 may also include a network interface (not shown) for connecting to one or more core network entities. The apparatus 1300 may optionally include a component for storing information, such as, for example, a memory device/component 1356. The computer readable medium or the memory component 1356 may be operatively coupled to the other components of the apparatus 1300 via the bus 1352 or the like. The memory component 1356 may be adapted to store computer readable instructions and data for effecting the processes and behavior of the components 1312-1314, and subcomponents thereof, or the processor 1350, or the methods disclosed herein. The memory component 1356 may retain instructions for executing functions associated with the components 1312-1314. While shown as being external to the memory 1356, it is to be understood that the components 1312-1314 can exist within the memory 1356. It is further noted that the components in FIG. 13 may comprise processors, electronic devices, hardware devices, electronic sub-components, logical circuits, memories, software codes, firmware codes, etc., or any combination thereof.

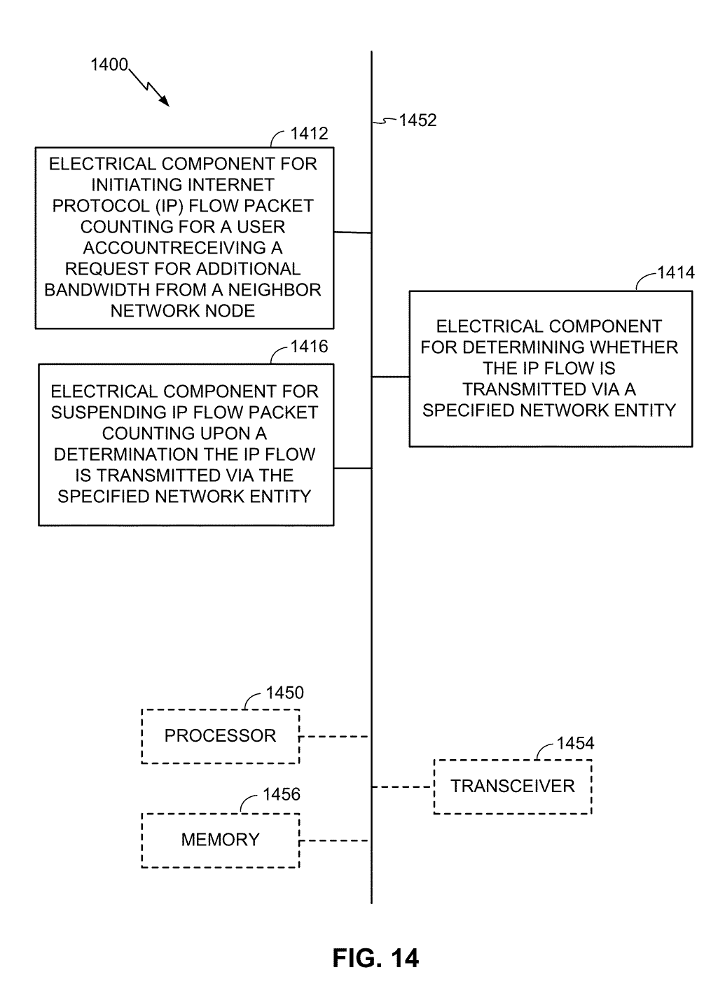

FIG. 14 shows another embodiment of an apparatus for controlling IP flow packet counting, in accordance with the methodology of FIG. 10. With reference to FIG. 14, there is provided an exemplary apparatus 1400 that may be configured as a network entity (e.g., a traffic management node or the like) in a network, or as a processor or similar device/component for use within the network entity. The apparatus 1400 may include functional blocks that can represent functions implemented by a processor, software, or combination thereof (e.g., firmware). For example, apparatus 1400 may include an electrical component or module 1412 for initiating internet protocol (IP) flow packet counting for a user account. The apparatus 1400 may also include a component 1414 for determining whether the IP flow is transmitted via a specified network entity. The apparatus 1400 may also include a component 1416 for suspending IP flow packet counting upon a determination the IP flow is transmitted via the specified network entity.

In related aspects, the apparatus 1400 may optionally include a processor component 1450 having at least one processor, in the case of the apparatus 1400 configured as a network entity, rather than as a processor. The processor 1450, in such case, may be in operative communication with the components 1412-1416 via a bus 1452 or similar communication coupling. The processor 1450 may effect initiation and scheduling of the processes or functions performed by electrical components 1412-1416.

In further related aspects, the apparatus 1400 may include a transceiver component 1454. A stand alone receiver and/or stand alone transmitter may be used in lieu of or in conjunction with the transceiver 1454. When the apparatus 1400 is a network entity, the apparatus 1400 may also include a network interface (not shown) for connecting to one or more core network entities. The apparatus 1400 may optionally include a component for storing information, such as, for example, a memory device/component 1456. The computer readable medium or the memory component 1456 may be operatively coupled to the other components of the apparatus 1400 via the bus 1452 or the like. The memory component 1456 may be adapted to store computer readable instructions and data for effecting the processes and behavior of the components 1412-1416, and subcomponents thereof, or the processor 1450, or the methods disclosed herein. The memory component 1456 may retain instructions for executing functions associated with the components 1412-1416. While shown as being external to the memory 1456, it is to be understood that the components 1412-1416 can exist within the memory 1456. It is further noted that the components in FIG. 14 may comprise processors, electronic devices, hardware devices, electronic sub-components, logical circuits, memories, software codes, firmware codes, etc., or any combination thereof.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A wireless communication method operable by a network entity, the method comprising:
determining whether an available bandwidth for communication by the network entity is below a bandwidth threshold;
requesting additional bandwidth from at least one neighbor network node in response to determining that the available bandwidth is below the bandwidth threshold; and
receiving configuration information from the at least one neighbor network node to increase the available bandwidth by at least a portion of the requested additional bandwidth.

2. The method of claim 1, wherein the available bandwidth is an available backhaul bandwidth, and the additional bandwidth is an additional backhaul bandwidth.

3. The method of claim 1, further comprising selecting a subset of network nodes from the at least one neighbor network node to provide the additional bandwidth, wherein the selecting is based on at least one of capabilities, bandwidth capacity, proximity to the current network entity, access restrictions, channel conditions, or proximity to at least one mobile entity.

4. The method of claim 3, further comprising:
initiating communication as at least one of a client, user, or UE of the subset of network nodes; and
relaying traffic to the subset of network nodes.

5. The method of claim 3, wherein the communication happens via WiFi Direct, LTE Direct, UMTS, or a backhaul.

6. The method of claim 3, wherein the relaying happens via WiFi Direct, LTE Direct, or UMTS.

7. The method of claim 1, wherein the requesting comprises requesting through at least one of an over-the-air link or a backhaul link.

8. The method of claim 1, wherein the determining comprises determining based on at least one of active probing, monitoring a success of uplink packets, or checking queuing delays of packets.

9. The method of claim 1, further comprising providing the additional bandwidth to at least one mobile entity.

10. The method of claim 9, further comprising providing the additional bandwidth for a predetermined period of time.

11. The method of claim 10, further comprising coordinating a handoff of the at least one mobile entity to a neighbor network node after the predetermined period of time expires.

12. The method of claim 9, wherein the additional bandwidth increases data throughput of the at least one mobile entity.

13. The method of claim 9, wherein the additional bandwidth reduces call setup and/or end-to-end latency.

14. The method of claim 9, wherein the providing the additional bandwidth is further based on at least one of a priority of the at least one mobile entity, and the priority is based on at least one of a network-specific service, a quality of service (QoS), a data throughput requirements, a circuit-switched or packet-switched service, category of the device, or association with a closed subscriber group identifier (CSG ID).

15. The method of claim 1, further comprising:
maintaining, at the network entity, at least one control plane of at least one mobile entity; and
switching at least one user plane of the at least one mobile entity to the at least one neighbor network node.

16. The method of claim 15, wherein the switching is performed using at least one of RANAP/RNSAP or S1AP/X2AP interfaces.

17. The method of claim 4, wherein the relaying comprises simultaneously relaying over the additional bandwidth at least a portion of a same mobile entity transmission using the available bandwidth.

18. A wireless communication apparatus comprising:
at least one processor configured to: determine whether an available bandwidth for communication by the network entity is below a bandwidth threshold; request additional bandwidth from at least one neighbor network node upon a determination that the available bandwidth is below the threshold; and receiving configuration information from the at least one neighbor network node to increase the available bandwidth by at least a portion of the requested additional bandwidth; and
a memory coupled to the at least one processor for storing data.

19. The wireless communication apparatus of claim 18, wherein the available bandwidth is an available backhaul bandwidth, and the additional bandwidth is an additional backhaul bandwidth.

20. The wireless communication apparatus of claim 18, wherein the at least one processor is further configured to select a subset of network nodes from the at least one neighbor network node to provide the additional bandwidth, wherein to select is based on at least one of capabilities, bandwidth capacity, proximity to the current network entity, access restrictions, channel conditions, or proximity to at least one mobile entity.

21. The wireless communication apparatus of claim 20, wherein the at least one processor is further configured to:
initiate communication as at least one of a client, user, or UE of the subset of network nodes; and
relay traffic to the subset of network nodes.

22. A wireless communication apparatus comprising:
means for determining whether an available bandwidth for communication by the network entity is below a bandwidth threshold;
means for requesting additional bandwidth from at least one neighbor network node in response to determining that the available bandwidth is below the bandwidth threshold; and
means for receiving configuration information from the at least one neighbor network node to increase the available bandwidth by at least a portion of the requested additional bandwidth.

23. The wireless communication apparatus of claim 22, wherein the available bandwidth is an available backhaul bandwidth, and the additional bandwidth is an additional backhaul bandwidth.

24. The wireless communication apparatus of claim 22, further comprising means for selecting a subset of network nodes from the at least one neighbor network node to provide the additional bandwidth, wherein selecting is based on at least one of capabilities, bandwidth capacity, proximity to the current network entity, access restrictions, channel conditions, or proximity to at least one mobile entity.

25. The wireless communication apparatus of claim 24, further comprising:
means for initiating communication as at least one of a client, user, or UE of the subset of network nodes; and
means for relaying traffic to the subset of network nodes.

26. A computer program product, comprising:
a computer-readable medium comprising code for causing at least one computer to:
determine whether an available bandwidth for communication by the network entity is below a bandwidth threshold;
request additional bandwidth from at least one neighbor network node in response to determining that the available bandwidth is below the bandwidth threshold; and
receive configuration information from the at least one neighbor network node to increase the available bandwidth by at least a portion of the requested additional bandwidth.

27. The computer program product of claim 26, wherein the available bandwidth is an available backhaul bandwidth, and the additional bandwidth is an additional backhaul bandwidth.

28. The computer program product of claim 26, wherein the computer-readable medium further comprises code for causing the at least one computer to select a subset of network nodes from the at least one neighbor network node to provide the additional bandwidth, wherein to select is based on at least one of capabilities, bandwidth capacity, proximity to the current network entity, access restrictions, channel conditions, or proximity to at least one mobile entity.

29. The computer program product of claim 28, wherein the computer-readable medium further comprises code for causing the at least one computer to:
initiate communication as at least one of a client, user, or UE of the subset of network nodes; and
relay traffic to the subset of network nodes.

30. A wireless communication method operable by a network entity, the method comprising:
receiving a request for additional bandwidth from a neighbor network node;
determining whether an available bandwidth for communication by the network entity is above a bandwidth threshold; and
providing configuration information to the neighbor network node to share a portion of the available bandwidth with the neighbor network node, in response to determining that the available bandwidth is above the threshold.

31. The method of claim 30, wherein the available bandwidth is an available backhaul bandwidth and/or air-link bandwidth, and the additional bandwidth is an additional backhaul bandwidth.

32. A wireless communication apparatus comprising:
at least one processor configured to: receive a request for additional bandwidth from a neighbor network node; determine whether an available bandwidth for communication by the network entity is above a bandwidth threshold; and provide configuration information to the neighbor network node to share a portion of the available bandwidth with the neighbor network node, in response to determining that the available bandwidth is above the threshold; and
a memory coupled to the at least one processor for storing data.

33. A wireless communication apparatus comprising:
means for receiving a request for additional bandwidth from a neighbor network node;
means for determining whether an available bandwidth for communication by the network entity is above a bandwidth threshold; and
means for providing configuration information to the neighbor network node to share a portion of the available bandwidth with the neighbor network node, in response to determining that the available bandwidth is above the threshold.

34. A computer program product, comprising:
a computer-readable medium comprising code for causing at least one computer to:
receive a request for additional bandwidth from a neighbor network node;
determine whether an available bandwidth for communication by the network entity is above a bandwidth threshold; and
provide configuration information to the neighbor network node to share a portion of the available bandwidth with the neighbor network node, in response to determining that the available bandwidth is above the threshold.

35. A wireless communication method operable by a network entity, the method comprising:
determining a bandwidth usage of at least one network node during at least one time period; and
adjusting a bandwidth capacity of the at least one network node based on the determined bandwidth usage.

36. The method of claim 35, wherein the determining further comprises determining by at least one of the network entity or receiving an indication from the at least one network node or via a different network entity.

37. The method of claim 35, wherein the adjusting is further based on at least one of a change in bandwidth usage or an average bandwidth usage.

38. The method of claim 35, wherein the adjusting further comprises at least one of increasing the bandwidth capacity or decreasing the bandwidth capacity for each network node of the at least one network node.

39. A wireless communication apparatus comprising:
at least one processor configured to: determine a bandwidth usage of at least one network node during at least one time period; and adjust a bandwidth capacity of the at least one network node based on the determined bandwidth usage; and
a memory coupled to the at least one processor for storing data.

40. The wireless communication apparatus of claim 39, wherein to determine further comprises to determine by at least one of the network entity or receiving an indication from the at least one network node or via a different network entity.

41. The wireless communication apparatus of claim 39, wherein to adjust is further based on at least one of a change in bandwidth usage or an average bandwidth usage.

42. The wireless communication apparatus of claim 39, wherein to adjust further comprises at least one of increasing the bandwidth capacity or decreasing the bandwidth capacity for each network node of the at least one network node.

43. A wireless communication apparatus comprising:
means for determining a bandwidth usage of at least one network node during at least one time period; and
means for adjusting a bandwidth capacity of the at least one network node based on the determined bandwidth usage.

44. The wireless communication apparatus of claim 43, wherein the means for determining is further configured for determining by at least one of the network entity or receiving an indication from the at least one network node or via a different network entity.

45. The wireless communication apparatus of claim 43, wherein the means for adjusting is based on at least one of a change in bandwidth usage or an average bandwidth usage.

46. The wireless communication apparatus of claim 43, wherein the means for adjusting is further configured for at least one of increasing the bandwidth capacity or decreasing the bandwidth capacity for each network node of the at least one network node.

47. A computer program product, comprising:
a computer-readable medium comprising code for causing at least one computer to:
determine a bandwidth usage of at least one network node during at least one time period; and
adjust a bandwidth capacity of the at least one network node based on the determined bandwidth usage.

48. The computer program product of claim 47, wherein to determine further comprises to determine by at least one of the network entity or receiving an indication from the at least one network node or via a different network entity.

49. The computer program product of claim 47, wherein to adjust is further based on at least one of a change in bandwidth usage or an average bandwidth usage.

50. The wireless communication apparatus of claim 47, wherein to adjust further comprises at least one of increasing the bandwidth capacity or decreasing the bandwidth capacity for each network node of the at least one network node.

51. A wireless communication method operable by a network entity, the method comprising:
initiating internet protocol (IP) flow packet counting for a user account;
determining whether the IP flow is transmitted via a specified network entity; and
suspending IP flow packet counting upon a determination the IP flow is transmitted via the specified network entity.

52. The method of claim 51, wherein the specified network entity comprises a femtocell, and determining comprises determining the IP flow is transmitted via the femtocell based on the IP flow terminating at one of a home nodeB gateway (HNB-GW), home EnodeB gateway (HeNB-GW), or mobility management entity (MME) or serving gateway (SGW) or serving GPRS support node (SGSN) or gateway GPRS support node (GGSN) or security gateway (SeGW) or other entity or subnet known as termination point or subnet for IP flows associated with femtocells.

53. The method of claim 51, further comprising:
determining at least one of a data throughput limit or data capacity limit for the user account, and
at least one of reducing data throughput based on a count of packets of the IP flow meeting or exceeding a threshold associated with the data throughput limit, or affecting delivery of the IP flow based on the count of the packets of the IP flow meeting or exceeding the data capacity limit.

54. The method of claim 51, further comprising:
determining whether the IP flow is transmitted for another user, wherein the suspending the IP flow packet counting is further based on determining the IP flow is transmitted for the another user.

55. The method of claim 54, wherein the anther user is a second user different from a first user associated with the user account.

56. The method of claim 54, wherein determining comprises determining based on an indication of the second user from a femtocell, a home nodeB (HNB), home EnodeB HeNB, mobility management entity (MME), or policy and charging rules function (PCRF) of a network entity.

57. The method of claim 54, wherein the determining whether the IP flow is transmitted for the second user is based on inspecting each packet of the IP flow for a transport layer address not associated with the first user.

58. The method of claim 54, wherein the determining whether the IP flow is transmitted for the second user is based on determining a transport layer address is not associated with the first user at a core network (CN).

59. The method of claim 56, wherein the transport layer address termination in the CN is allocated by MME or SGSN or H(e)NB-GW.

60. The method of claim 58, wherein the transport layer address is designated according to each user's membership to the femtocell or femtocell's closed access group.

61. The method of claim 54, wherein determining comprises of monitoring control plane protocol (HNBAP, RANAP, S1AP) whence the users' membership to a femtocell can be determined.

62. A wireless communication apparatus comprising:
at least one processor configured to: initiate internet protocol (IP) flow packet counting for a user account, determine whether the IP flow is transmitted via a specified network entity, and suspend IP flow packet counting upon a determination the IP flow is transmitted via the specified network entity; and
a memory coupled to the at least one processor for storing data.

63. The wireless communication apparatus of claim 62, wherein the specified network entity comprises a femtocell, and to determine comprises to determine the IP flow is transmitted via the femtocell based on the IP flow terminating at one of a home nodeB gateway (HNB-GW), home EnodeB gateway (HeNB-GW), or mobility management entity (MME) or serving gateway (SGW) or serving GPRS support node (SGSN) or gateway GPRS support node (GGSN) or security gateway (SeGW) or other entity or subnet known as termination point or subnet for IP flows associated with femtocells.

64. The wireless communication apparatus of claim 62, wherein the at least one processor is further configured to:
determine at least one of a data throughput limit or data capacity limit for the user account, and
at least one of reducing data throughput based on a count of packets of the IP flow meeting or exceeding a threshold associated with the data throughput limit, or affecting delivery of the IP flow based on the count of the packets of the IP flow meeting or exceeding the data capacity limit.

65. The wireless communication apparatus of claim 62, wherein the at least one processor is further configured to determine whether the IP flow is transmitted for another user, wherein to suspend the IP flow packet counting is further based on determining the IP flow is transmitted for the another user.

66. A wireless communication apparatus comprising:
means for initiating internet protocol (IP) flow packet counting for a user account;
means for determining whether the IP flow is transmitted via a specified network entity; and
means for suspending IP flow packet counting upon a determination the IP flow is transmitted via the specified network entity.

67. The wireless communication apparatus of claim 66, wherein the specified network entity comprises a femtocell, and the means for determining is configured for determining the IP flow is transmitted via the femtocell based on the IP flow terminating at one of a home nodeB gateway (HNB-GW), home EnodeB gateway (HeNB-GW), or mobility management entity (MME) or serving gateway (SGW) or serving GPRS support node (SGSN) or gateway GPRS support node (GGSN) or security gateway (SeGW) or other entity or subnet known as termination point or subnet for IP flows associated with femtocells.

68. The wireless communication apparatus of claim 66, further comprising:
means for determining at least one of a data throughput limit or data capacity limit for the user account, and
means for at least one of reducing data throughput based on a count of packets of the IP flow meeting or exceeding a threshold associated with the data throughput limit, or affecting delivery of the IP flow based on the count of the packets of the IP flow meeting or exceeding the data capacity limit.

69. The wireless communication apparatus of claim 66, further comprising means for determining whether the IP flow is transmitted for another user, wherein the means for suspending the IP flow packet counting is further based on determining the IP flow is transmitted for the another user.

70. A computer program product, comprising:
a computer-readable medium comprising code for causing at least one computer to:
initiate internet protocol (IP) flow packet counting for a user account;
determine whether the IP flow is transmitted via a specified network entity; and
suspend IP flow packet counting upon a determination the IP flow is transmitted via the specified network entity.

71. The computer program product of claim 70, wherein the specified network entity comprises a femtocell, and the means for determining is configured for determining the IP flow is transmitted via the femtocell based on the IP flow terminating at one of a home nodeB gateway (HNB-GW), home EnodeB gateway (HeNB-GW), or mobility management entity (MME) or serving gateway (SGW) or serving GPRS support node (SGSN) or gateway GPRS support node (GGSN) or security gateway (SeGW) or other entity or subnet known as termination point or subnet for IP flows associated with femtocells.

72. The computer program product of claim 70, wherein the computer-readable medium further comprises code for causing the at least one computer to:
determine at least one of a data throughput limit or data capacity limit for the user account, and
at least one of reduce data throughput based on a count of packets of the IP flow meeting or exceeding a threshold associated with the data throughput limit, or affect delivery of the IP flow based on the count of the packets of the IP flow meeting or exceeding the data capacity limit.

73. The computer program product of claim 70, wherein the computer-readable medium further comprises code for causing the at least one computer to determine whether the IP flow is transmitted for another user, wherein to suspend the IP flow packet counting is further based on determining the IP flow is transmitted for the another user.
